(19) United States
(12) Patent Application Publication
(10) Pub. No.: US 2018/0254458 A1
(43) Pub. Date: Sep. 6, 2018

(54) NONAQUEOUS ELECTROLYTE SECONDARY BATTERY SEPARATOR

(71) Applicant: Sumitomo Chemical Company, Limited, Tokyo (JP)

(72) Inventors: Ichiro ARISE, Osaka (JP); Chikara MURAKAMI, Osaka (JP)

(21) Appl. No.: 15/910,548

(22) Filed: Mar. 2, 2018

(30) Foreign Application Priority Data
Mar. 3, 2017 (JP) 2017-041095

(51) Int. Cl. H01M 2/16; H01M 2/14

(52) U.S. Cl. CPC H01M 2/1653; H01M 10/0525; H01M 2/1686; H01M 2/145

(57) ABSTRACT

A nonaqueous electrolyte secondary battery separator including a polyolefin porous film, wherein a magnitude of a slope of a tangent in a region II of an ultrasonic attenuation rate curve of the nonaqueous electrolyte secondary battery separator immersed in an electrolyte is not less than 100 mV/s to not more than 1450 mV/s, makes it possible to provide a nonaqueous electrolyte secondary battery having a low battery resistance increasing rate after charge and discharge (after a degassing operation).

This Nonprovisional application claims priority under 35 U.S.C. § 119 on Patent Application No. 2017-041095 filed in Japan on Mar. 3, 2017, the entire contents of which is hereby incorporated by reference.

### TECHNICAL FIELD

The present invention relates to a separator for a nonaqueous electrolyte secondary battery (hereinafter referred to as a “nonaqueous electrolyte secondary battery separator”).

### BACKGROUND ART

Nonaqueous electrolyte secondary batteries such as a lithium secondary battery are currently in wide use as (i) batteries for devices such as a personal computer, a mobile telephone, and a portable information terminal or (ii) on-vehicle batteries.

As a separator for use in such a nonaqueous electrolyte secondary battery, a porous film containing polyolefin as a main component, as disclosed in, for example, Patent Literature 1 is known.

Meanwhile, Patent Literature 2 discloses the invention in which, in order to provide an electrode plate for use in a nonaqueous electrolyte secondary battery which exhibits high output characteristic at a quick charge and discharge, an electrode plate is immersed in a measurement solvent, measurement of changes in intensity of transmitted ultrasonic wave over time is started immediately after the immersion, and an attention is focused on a maximum value of a rate of increase in intensity of transmitted ultrasonic wave over a period of time from a rise of the intensity of transmitted ultrasonic wave to a saturation thereof within a one-minute period from the start of the measurement.

### CITATION LIST

### Patent Literature

[Patent Literature 1

Japanese Patent Application Publication, Tokukaihei, No. 11-130900 (1999) (Publication Date: May 18, 1999)

[Patent Literature 2

Japanese Patent Application Publication, Tokukai, No. 2007-103040 (Publication Date: Apr. 19, 2007)

### SUMMARY OF INVENTION

### Technical Problem

Unfortunately, nonaqueous electrolyte secondary batteries including any of the nonaqueous electrolyte secondary battery separators known in the art, including the nonaqueous electrolyte secondary battery separator disclosed in Patent Literature 1, can have an increased battery resistance after charge and discharge. Such a problem needs to be addressed.

Thus, it is an object of the present invention to provide a nonaqueous electrolyte secondary battery separator that makes it possible to provide a nonaqueous electrolyte secondary battery that reduces an increase in battery resistance after charge and discharge.

### Solution to Problem

The present invention includes the following [1] through [4]:

[1] A nonaqueous electrolyte secondary battery separator including a polyolefin porous film, wherein a magnitude of a slope of a tangent in a region II of an ultrasonic attenuation rate curve of the nonaqueous electrolyte secondary battery separator immersed in an electrolyte is not less than 100 mV/s to not more than 1450 mV/s, where the ultrasonic attenuation rate curve shows changes over time in ultrasonic attenuation rate of a 2 MHz ultrasonic wave emitted to the nonaqueous electrolyte secondary battery separator immersed in the electrolyte, and the region II indicates, on the ultrasonic attenuation rate curve, a region extending from a first inflection point of the ultrasonic attenuation rate to a second inflection point of the ultrasonic attenuation rate.

[2] A nonaqueous electrolyte secondary battery laminated separator including: a nonaqueous electrolyte secondary battery separator as described in [1]; and an insulating porous layer.

[3] A nonaqueous electrolyte secondary battery member including: a positive electrode; a nonaqueous electrolyte secondary battery separator as described in [1] or a nonaqueous electrolyte secondary battery laminated separator as described in [2]; and a negative electrode, the positive electrode, the nonaqueous electrolyte secondary battery separator or the nonaqueous electrolyte secondary battery laminated separator, and the negative electrode being disposed in this order.

[4] A nonaqueous electrolyte secondary battery including: a nonaqueous electrolyte secondary battery separator as described in [1] or a nonaqueous electrolyte secondary battery laminated separator as described in [2].

Patent Literature 2 discloses measuring changes over time in intensity of transmitted ultrasonic wave for an electrode plate for use in a nonaqueous electrolyte secondary battery, in order to provide an electrode plate for use in a nonaqueous electrolyte secondary battery which exhibits high output characteristic. However, the invention disclosed in Patent Literature 2 is quite different from the present invention in problem to be solved and in object.

### Advantageous Effects of Invention

A nonaqueous electrolyte secondary battery separator in accordance with an embodiment of the present invention yields the effect of allowing a nonaqueous electrolyte secondary battery into which the nonaqueous electrolyte secondary battery separator is incorporated to reduce an increase in battery resistance after charge and discharge (after a degassing operation).

### BRIEF DESCRIPTION OF DRAWINGS

FIG. 1 is a diagram schematically illustrating a device and method for measuring an ultrasonic attenuation rate of a nonaqueous electrolyte secondary battery separator immersed in an electrolyte.

FIG. 2 is a graph showing an example of an ultrasonic attenuation rate curve (t=0 seconds to 300 seconds) of a nonaqueous electrolyte secondary battery separator immersed in an electrolyte.

FIG. 3 is an enlarged view of regions, corresponding to t=0 seconds to 5 seconds, of the ultrasonic attenuation rate curve shown in FIG. 2.

### DESCRIPTION OF EMBODIMENTS

The following description will discuss an embodiment of the present invention. Note, however, that the present invention is not limited to the embodiment below. The present invention is not limited to the arrangements described below, but may be altered in various ways by a skilled person within the scope of the claims. Any embodiment based on a proper combination of technical means disclosed in different embodiments is also encompassed in the technical scope of the present invention. Note that numerical expressions such as “A to B” herein mean “not less than A and not more than B” unless otherwise stated.

### Embodiment 1: Nonaqueous Electrolyte Secondary Battery Separator

A nonaqueous electrolyte secondary battery separator in accordance with Embodiment 1 of the present invention is a nonaqueous electrolyte secondary battery separator including a polyolefin porous film, wherein a magnitude of a slope of a tangent in a region II of an ultrasonic attenuation rate curve of the nonaqueous electrolyte secondary battery separator immersed in an electrolyte is not less than 100 mV/s to not more than 1450 mV/s.

Here, the region II indicates, on an ultrasonic attenuation rate curve that shows changes over time in ultrasonic attenuation rate of a 2 MHz ultrasonic wave emitted to a nonaqueous electrolyte secondary battery separator immersed in an electrolyte, a region extending from a first inflection point of the ultrasonic attenuation rate to a second inflection point of the ultrasonic attenuation rate.

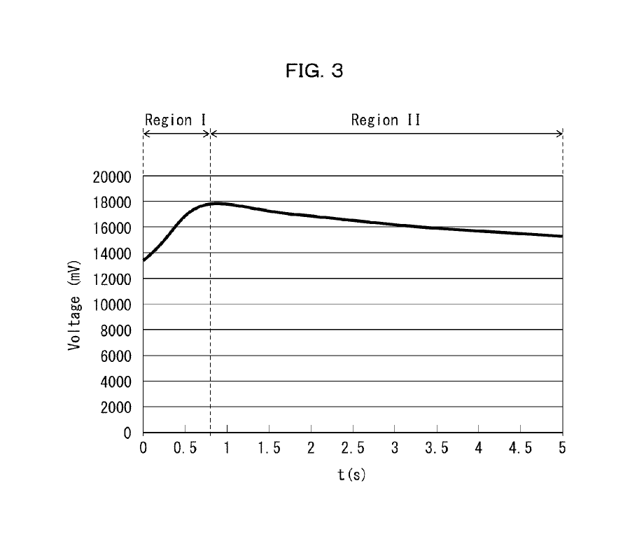

The “ultrasonic attenuation rate” is a ratio of the intensity of an ultrasonic wave passing through the nonaqueous electrolyte secondary battery separator to the intensity of the ultrasonic wave emitted to the nonaqueous electrolyte secondary battery separator. Further, the “ultrasonic attenuation rate curve” is a curve showing a relation between (i) an ultrasonic attenuation rate of an ultrasonic wave emitted to a nonaqueous electrolyte secondary battery separator immersed in a nonaqueous electrolyte and (ii) an immersion time t. FIGS. 2 and 3 show an example of the ultrasonic attenuation rate curve. FIG. 2 is a graph showing an example of an ultrasonic attenuation rate curve (t=0 seconds to 300 seconds) of a nonaqueous electrolyte secondary battery separator immersed in an electrolyte. FIG. 3 is an enlarged view of regions, corresponding to t=0 seconds to 5 seconds, of the ultrasonic attenuation rate curve shown in FIG. 2. Regarding a method for measuring an ultrasonic attenuation rate and a method for generating an ultrasonic attenuation rate curve, the description provided later and the description in Examples should be referred to.

An ultrasonic attenuation rate (vertical axis) of the ultrasonic attenuation rate curve shown in FIGS. 2 and 3 is converted and expressed in voltage (mV) indicated by a DC-DC converter as shown in Examples described later. Here, a higher voltage implies a lower ultrasonic attenuation rate, that is, easier ultrasonic wave propagation.

As shown in FIG. 3, a voltage on the ultrasonic attenuation rate curve increases with the passage of time immediately after the nonaqueous electrolyte secondary battery separator is immersed in the nonaqueous electrolyte, and then begins to decrease. Thereafter, the voltage on the ultrasonic attenuation rate curve begins to increase again as shown in FIG. 2. In other words, the ultrasonic attenuation rate decreases with the passage of time immediately after the nonaqueous electrolyte secondary battery separator is immersed in the nonaqueous electrolyte, and then begins to increase at the first inflection point. Thereafter, the ultrasonic attenuation rate decreases again at the second inflection point. That is, it can be said that an ultrasonic wave tends to become difficult to propagate through the nonaqueous electrolyte secondary battery separator at the first inflection point with the passage of time, and then reverses its tendency and begins to become easy to propagate through the nonaqueous electrolyte secondary battery separator at the second inflection point. Here, the “region I” herein indicates a region extending from the start (t=0) of the immersion of the nonaqueous electrolyte secondary battery separator into an electrolyte to the first inflection point of the ultrasonic attenuation rate curve, the “region II” herein indicates a region extending from the first inflection point to the second inflection point of the ultrasonic attenuation rate curve, and the “region III” herein indicates a region following the second inflection point of the ultrasonic attenuation rate curve (see FIGS. 2 and 3).

When the nonaqueous electrolyte secondary battery separator is immersed into the nonaqueous electrolyte, the nonaqueous electrolyte (liquid) enters voids of the nonaqueous electrolyte secondary battery separator. In the region I, there occurs a phenomenon in which the nonaqueous electrolyte adheres to the surfaces of the nonaqueous electrolyte secondary battery separator. In the region II, there occurs a phenomenon in which the electrolyte enters multiple voids inside the separator, and air present within the multiple voids collects to form a large void (air bubble). A large air bubble present in such a large void greatly scatters an ultrasonic wave and thus attenuates an ultrasonic wave signal.

Here, it is known that an attenuation rate of an ultrasonic wave (sound) varies depending on the type of medium through which the ultrasonic wave (sound) propagates, and an attenuation rate of an ultrasonic wave (sound) propagating through liquid is lower than that of an ultrasonic wave (sound) propagating through air.

In the region I in which the nonaqueous electrolyte contacts the surfaces of the nonaqueous electrolyte secondary battery separator, air on the surfaces of the separator is replaced with the nonaqueous electrolyte, through which an ultrasonic wave is more likely to propagate, and the ultrasonic attenuation rate thus decreases. Consequently, the voltage on the ultrasonic attenuation rate curve increases. On the other hand, in the region II, the air present in the voids inside the nonaqueous electrolyte secondary battery separator is moved and collected under pressure of the nonaqueous electrolyte. This forms a large air bubble. Since the large air bubble (air) is more likely to scatter an ultrasonic wave than a small air bubble, the ultrasonic attenuation rate increases in the region II (that is, the voltage on the ultrasonic attenuation rate curve decreases).

Therefore, it is considered that the magnitude of the slope of the tangent in the region II of the ultrasonic attenuation rate curve indicates easiness of permeation of the electrolyte into the nonaqueous electrolyte secondary battery separator and easiness of formation of a large air bubble in the void of the nonaqueous electrolyte secondary battery separator. Further, easiness of formation of a large air bubble is considered to be influenced by the structure of the void of the nonaqueous electrolyte secondary battery separator and by flexibility of a resin which is contained in the nonaqueous electrolyte secondary battery separator. Note that the “magnitude of the slope of the tangent” means an absolute value of the slope of the tangent.

In a case where the magnitude of the slope of the tangent in the region II of the ultrasonic attenuation rate curve is too large, a permeability of the electrolyte into the nonaqueous electrolyte secondary battery separator is too high, that is, an affinity is too high between the nonaqueous electrolyte secondary battery separator and the electrolyte. This causes the electrolyte to be retained with a high affinity on a separator side and thus interferes with movement of the nonaqueous electrolyte toward the electrodes. This is considered to be the reason why a battery resistance after charge and discharge increases. Further, when a large air bubble is easily formed, it means that a large air bubble is more likely to remain and is less likely to be removed. Thus, a large air bubble thus formed may not be removed from the inside of the separator even after a degassing operation. Such a remained large air bubble interferes with ionic conduction and thus increases a battery resistance. From this viewpoint, the magnitude of the slope of the tangent in the region II of the ultrasonic attenuation rate curve of the nonaqueous electrolyte secondary battery separator in accordance with an embodiment of the present invention is not more than 1450 mV/s, preferably not more than 1400 mV/s, and more preferably not more than 1350 mV/s.

On the other hand, in a case where the magnitude of the slope of the tangent in the region II of the ultrasonic attenuation rate curve is too small, an affinity is too low between the nonaqueous electrolyte secondary battery separator and the electrolyte. This prevents the electrolyte from being sufficiently permeated throughout the entire separator. Consequently, it is considered that a battery resistance does not decrease. From this viewpoint, the magnitude of the slope of the tangent in the region II of the ultrasonic attenuation rate curve of the nonaqueous electrolyte secondary battery separator in accordance with an embodiment of the present invention is not less than 100 mV/s, preferably not less than 110 mV/s, and more preferably not less than 120 mV/s.

A nonaqueous electrolyte secondary battery into which a nonaqueous electrolyte secondary battery separator in accordance with an embodiment of the present invention is incorporated is such that a battery resistance increasing rate after a degassing operation is less than 100%, which indicates that an increase in battery resistance after charge and discharge (particularly after the degassing operation) is reduced, as shown in Examples described later. Here, the “degassing operation”, which is an operation that is performed, after assembly of a nonaqueous electrolyte secondary battery, to use the nonaqueous electrolyte secondary battery as a battery, is an operation that includes: a first charging and discharging step of subjecting a nonaqueous electrolyte secondary battery not having been subjected to charge and discharge to one cycle of charge and discharge at low rate; and a degassing step of discharging gas that generates in the first charging and discharging step. The degassing step can be performed by any method. Examples of the method include a method using a vacuum sealer.

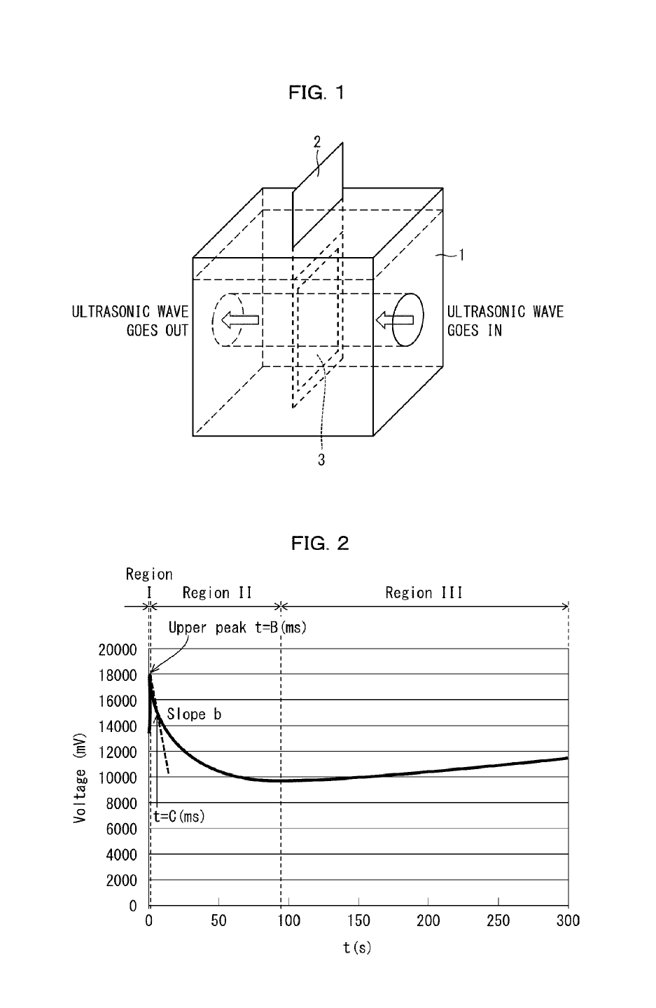

Here, generation of the ultrasonic attenuation rate curve and determination of the slope of the tangent in the region II of the ultrasonic attenuation rate curve are performed by, for example, the following procedure. Measurement of the ultrasonic attenuation rate can be carried out with use of a dynamic liquid permeability measurement device (manufactured by EMTEC Electronic GmbH; dynamic liquid permeability measurement device: PDA.C.02 Module Standard). FIG. 1 is a diagram schematically illustrating the dynamic liquid permeability measurement device.

First, a nonaqueous electrolyte is prepared by mixing ethyl carbonate (also referred to as “EC”), ethyl methyl carbonate (also referred to as “EMC”), and diethyl carbonate (also referred to as “DEC”) in a volume ratio of 3:5:2. Next, the nonaqueous electrolyte is put into a tub 1 which is included with the dynamic liquid permeability measurement device, until the nonaqueous electrolyte reaches a reference line of the tub 1.

Then, a nonaqueous electrolyte secondary battery separator 3 is attached, with a double-sided tape included with the dynamic liquid permeability measurement device, to a sample holder 2 included with the dynamic liquid permeability measurement device in a sample attachment area provided on the sample holder 2. This prepares a specimen to be measured.

Subsequently, the specimen to be measured is attached to the dynamic liquid permeability measurement device, and measurement of the ultrasonic attenuation rate is carried out under the following measurement conditions, set with use of software which is included with the dynamic liquid permeability measurement device, in which algorithm is General, a measurement frequency is 2 MHz, and a measurement diameter is 10 mm.

The measurement of the ultrasonic attenuation rate is started with a press of a test start button of the dynamic liquid permeability measurement device. A time when the test start button is pressed is defined as t=0 ms. When the test start button is pressed, the specimen to be measured including the sample holder 2 starts being dropped into the tub 1, which is filled with the nonaqueous electrolyte, at a constant velocity by use of a constant-velocity motor, and then reaches a measurement position of the tub 1 over a drop time (t=6 ms). Then, first measurement data of the ultrasonic attenuation rate is obtained at a time of t=7 ms, and thereafter, the ultrasonic attenuation rate is measured at a measurement interval of 4 ms. Immediately after the start of the measurement, a value corresponding to a least point that appears on a vertical axis of a measurement state monitoring graph on a computer is written down, and the value corresponding to the least point is defined as a value of an ultrasonic attenuation rate at the time of t=7 ms.

Note that although the least point is expressed in no unit on the computer, the least point indicates a value of a voltage of the DC-DC converter. Thus, the ultrasonic attenuation rate measured by the above-described method is expressed in the unit of mV.

From the measurements of the ultrasonic attenuation rate, changes in ultrasonic attenuation rate with the passage of time are plotted to generate an ultrasonic attenuation rate curve as shown in FIG. 2. In the region II of the ultrasonic attenuation rate curve, a time when the first inflection point of the ultrasonic attenuation rate curve is reached after the start of the measurement is defined as t=B ms. A point corresponding to the value of the ultrasonic attenuation rate at t=B ms is connected to its subsequent given measurement points, and a tangent is drawn by using a least-squares method. Assuming that a time at which a correlation coefficient in the least-squares method is closest to 0.985 is t=C ms, the slope of a line connecting the points of the ultrasonic attenuation rate at t=B ms and at t=C ms is calculated. An absolute value of the slope thus calculated of the line is defined as a magnitude b of the slope in the region II of the ultrasonic attenuation rate.

Alternatively, assuming that the ultrasonic attenuation rate at the first data measurement time of t=7 ms is 100%, another ultrasonic attenuation rate curve may be generated by a method similar to the above-described method. Then, based on the another ultrasonic attenuation rate curve, a magnitude b′ of a slope of a tangent in the region II of the another ultrasonic attenuation rate curve may be calculated by a method similar to the above-described calculation method. In this case, the magnitude of the slope of the tangent in the region II of the ultrasonic attenuation rate curve of the nonaqueous electrolyte secondary battery separator in accordance with an embodiment of the present invention is not less than 0.5%/s (preferably not less than 0.7%/s, more preferably not less than 1%/s) to not more than 10%/s (preferably not more than 9%/s, more preferably not more than 8%/s).

The nonaqueous electrolyte used in the above method for measuring the ultrasonic attenuation rate is a mixed electrolyte in which EC, EMC, and DEC are mixed in a volume ratio of 3:5:2. However, another nonaqueous electrolyte usable in a nonaqueous electrolyte secondary battery can be used alternatively. The nonaqueous electrolyte usable in a nonaqueous electrolyte secondary battery has an electrical conduction property within a certain range. Thus, affinity between the another nonaqueous electrolyte and a nonaqueous electrolyte secondary battery separator is equal to affinity between the mixed electrolyte and a nonaqueous electrolyte secondary battery separator. Therefore, the magnitude of a slope of a tangent in the region II of the above-described ultrasonic attenuation rate curve obtained when the another nonaqueous electrolyte is used becomes substantially the same as the magnitude of a slope of a tangent in the region II of the above-described ultrasonic attenuation rate curve obtained when the mixed electrolyte is used.

The nonaqueous electrolyte secondary battery separator in accordance with Embodiment 1 of the present invention includes a polyolefin porous film, and is preferably constituted by a polyolefin porous film. Note, here, that the “polyolefin porous film” is a porous film which contains a polyolefin-based resin as a main component. Note that the phrase “contains a polyolefin-based resin as a main component” means that a porous film contains a polyolefin-based resin at a proportion of not less than 50% by volume, preferably not less than 90% by volume, and more preferably not less than 95% by volume, relative to the whole of materials of which the porous film is made.

The polyolefin porous film can be the nonaqueous electrolyte secondary battery separator in accordance with an embodiment of the present invention or a base material of a nonaqueous electrolyte secondary battery laminated separator in accordance with an embodiment of the present invention, which will be described later. The polyolefin porous film has therein many pores, connected to one another, so that a gas and/or a liquid can pass through the polyolefin porous film from one side to the other side.

The polyolefin-based resin more preferably contains a high molecular weight component having a weight-average molecular weight of 3×10⁵ to 15×10⁶. In particular, the polyolefin-based resin more preferably contains a high molecular weight component having a weight-average molecular weight of not less than 1,000,000 because the polyolefin porous film and a nonaqueous electrolyte secondary battery laminated separator including such a polyolefin porous film each have a higher strength.

Examples of the polyolefin-based resin which the polyolefin porous film contains as a main component include, but are not particularly limited to, homopolymers (for example, polyethylene, polypropylene, and polybutene) and copolymers (for example, ethylene-propylene copolymer) both of which are thermoplastic resins and are each produced through (co)polymerization of a monomer(s) such as ethylene, propylene, 1-butene, 4-methyl-1-pentene, and/or 1-hexene. The polyolefin porous film can include a layer containing only one of these polyolefin-based resins or a layer containing two or more of these polyolefin-based resins. Among these, polyethylene is more preferable as it is capable of preventing (shutting down) a flow of an excessively large electric current at a lower temperature. A high molecular weight polyethylene containing ethylene as a main component is particularly preferable. Note that the polyolefin porous film can contain a component(s) other than polyolefin as long as such a component does not impair the function of the layer.

Examples of the polyethylene include low-density polyethylene, high-density polyethylene, linear polyethylene (ethylene-α-olefin copolymer), and ultra-high molecular weight polyethylene having a weight-average molecular weight of not less than 1,000,000. Among these examples, ultra-high molecular weight polyethylene having a weight-average molecular weight of not less than 1,000,000 is preferable. It is more preferable that the polyethylene contain a high molecular weight component having a weight-average molecular weight of 5×10⁵ to 15×10⁶.

The thickness of the polyolefin porous film is not particularly limited, but is preferably 4 μm to 40 μm, and more preferably 5 μm to 20 μm.

The thickness of the polyolefin porous film is preferably not less than 4 μm since an internal short circuit of a battery can be sufficiently prevented with such a thickness.

On the other hand, the thickness of the polyolefin porous film is preferably not more than 40 μm since an increase in size of a nonaqueous electrolyte secondary battery can be prevented with such a thickness.

The polyolefin porous film typically has a weight per unit area of preferably 4 g/m² to 20 g/m², and more preferably 5 g/m² to 12 g/m², so as to allow a nonaqueous electrolyte secondary battery to have a higher weight energy density and a higher volume energy density.

The polyolefin porous film has an air permeability of preferably 30 sec/100 mL to 500 sec/100 mL, and more preferably 50 sec/100 mL to 300 sec/100 mL, in terms of Gurley values, since a sufficient ion permeability is exhibited with such an air permeability.

The polyolefin porous film has a porosity of preferably 20% by volume to 80% by volume, and more preferably 30% by volume to 75% by volume, so as to (i) retain a larger amount of electrolyte and (ii) obtain the function of reliably preventing (shutting down) a flow of an excessively large electric current at a lower temperature.

The polyolefin porous film has a pore diameter of preferably not more than 0.3 μm and more preferably not more than 0.14 μm, in view of sufficient ion permeability and of preventing particles, constituting an electrode, from entering the pores of the polyolefin porous film.

The nonaqueous electrolyte secondary battery separator in accordance with an embodiment of the present invention may include a porous layer as needed, in addition to the polyolefin porous film. Examples of the porous layer encompass an insulating porous layer constituting the nonaqueous electrolyte laminated separator (described later) (hereinafter also referred to simply as “porous layer”) and, as other porous layers, publicly known porous layers such as a heat-resistant layer, an adhesive layer, and a protective layer.

[Method for producing polyolefin porous film] Examples of a method for producing the polyolefin porous film include, but are not particularly limited to, a method in which a polyolefin-based resin, an additive (i), which is in solid form at normal temperature, and an additive (ii), which is in liquid form at normal temperature, are kneaded and then extruded to obtain a sheet-shaped polyolefin resin composition, the polyolefin resin composition thus obtained is stretched, and then the polyolefin resin composition is subjected to cleaning with a suitable solvent, drying, and heat fixing.

Specifically, the method can be a method including the following steps of:

(A) melt-kneading a polyolefin-based resin and an additive (i), which is in solid form at normal temperature, in a kneader to obtain a molten mixture;

(B) putting an additive (ii), which is in liquid form at normal temperature, into the kneader to mix the additive (ii) with the molten mixture having been obtained in the step (A) and then kneading a mixture to obtain a polyolefin resin composition;

(C) extruding, through a T-die of an extruder, the polyolefin resin composition having been obtained in the step (B), and then shaping the polyolefin resin composition into a sheet while cooling the polyolefin resin composition, so that a sheet-shaped polyolefin resin composition is obtained;

(D) stretching the sheet-shaped polyolefin resin composition having been obtained in the step (C);

(E) cleaning, with use of a cleaning liquid, the polyolefin resin composition having been stretched in the step (D); and

(F) drying and heat fixing the polyolefin resin composition having been cleaned in the step (E), so that a polyolefin porous film is obtained.

In the step (A), the polyolefin-based resin is used in an amount of preferably 6% by weight to 45% by weight, and more preferably 9% by weight to 36% by weight, with respect to 100% by weight of the polyolefin resin composition to be obtained.

Examples of the additive (i) used in the step (A) include petroleum resin. The petroleum resin is preferably an aliphatic hydrocarbon resin having a softening point of 90° C. to 125° C. or an alicyclic saturated hydrocarbon resin having a softening point of 90° C. to 125° C., and more preferably the alicyclic saturated hydrocarbon resin having a softening point of 90° C. to 125° C. The petroleum resin has unsaturated bonds, which tend to generate radicals, and tertiary carbon in its structure and thus has the characteristics of being more likely to be oxidized than polyolefin. Addition of the petroleum resin allows a resultant polyolefin porous film to be oxidized to an appropriate extent. This tends to increase an affinity between the polyolefin porous film and a nonaqueous electrolyte. The additive (i) is used in an amount of preferably 0.5% by weight to 40% by weight, and more preferably 1% by weight to 30% by weight, with respect to 100% by weight of the polyolefin resin composition to be obtained.

Examples of the additive (ii) used in the step (B) include: phthalate esters such as dioctyl phthalate; unsaturated higher alcohol such as oleyl alcohol; saturated higher alcohol such as stearyl alcohol; low molecular weight polyolefin-based resin such as paraffin wax; and liquid paraffin. The additive (ii) is preferably a plasticizing agent, such as liquid paraffin, which serves as a pore forming agent.

The additive (ii) is used in an amount of preferably 50% by weight to 90% by weight, and more preferably 60% by weight to 85% by weight, with respect to 100% by weight of the polyolefin resin composition to be obtained.

In the step (B), an internal temperature of the kneader at the time of putting the additive (ii) into the kneader is preferably not lower than 140° C. to not higher than 200° C., more preferably not lower than 160° C. to not higher than 180° C., still more preferably not lower than 166° C. to not higher than 180° C. Controlling the internal temperature of the kneader to fall within the above range enables the additive (ii) to be put into the kneader in a state in which the polyolefin-based resin and the additive (i) are mixed suitably. Consequently, it is possible to more suitably obtain the effect of mixing the polyolefin-based resin and the additive (i).

In the step (D), it is possible to use a commercially-available stretching apparatus for stretching the sheet-shaped polyolefin resin composition. More specifically, the sheet-shaped polyolefin resin composition may be stretched by (i) a method in which an end of the sheet is seized by a chuck and the sheet is drawn, (ii) a method in which rollers for conveying the sheet are set at different rotation speeds so as to draw the sheet, or (iii) a method in which the sheet is rolled by using a pair of rollers.

Stretching is preferably performed both in the MD direction and in the TD direction. Examples of a method of stretching the sheet both in the MD direction and in the TD direction include: sequential biaxial stretching in which the sheet is first stretched in the MD direction and then stretched in the TD direction; and simultaneous biaxial stretching in which the sheet is simultaneously stretched in the MD direction and the TD direction.

The stretch magnification at which stretching is performed in the MD is preferably 4.0 times to 7.5 times, and more preferably 4.0 times to 6.5 times. The stretch magnification at which stretching is performed in the TD is preferably 4.0 times to 7.5 times, and more preferably 4.0 times to 6.5 times. Here, a ratio between the stretch magnification in the MD direction and the stretch magnification in the TD direction (a value obtained by dividing the stretch magnification in the MD direction by the stretch magnification in the TD direction or vice versa) is preferably 0.55 to 1.85, and more preferably 0.62 to 1.63. Setting the stretch magnification and the stretch magnification ratio to fall within the above ranges can adjust the structure of the void of the polyolefin porous film and the flexibility of the resin contained in the polyolefin porous film to suitable ranges. Specifically, when the stretch magnification ratio falls outside the above range, the void structure has a high degree of anisotropy. This is considered to be the reason why a large air bubble is less likely to be formed.

Stretching is performed at a temperature not higher than a melting point of a polyolefin-based resin, preferably not higher than 130° C., and more preferably 100° C. to 130° C.

The cleaning liquid used in the step (E) can be any solvent that can remove an additive such as a pore forming agent. Examples of the cleaning liquid include heptane and dichloromethane.

In the step (F), the heat fixing is performed at a temperature of preferably not lower than 80° C. to not higher than 140° C., and more preferably not lower than 100° C. to not higher than 135° C. The heat fixing is performed for a time of preferably not shorter than 0.5 minutes to not longer than 30 minutes, more preferably not shorter than 1 minute to not longer than 15 minutes.

### Embodiment 2: Nonaqueous Electrolyte Secondary Battery Laminated Separator

A nonaqueous electrolyte secondary battery laminated separator in accordance with Embodiment 2 of the present invention includes (i) a nonaqueous electrolyte secondary battery separator in accordance with Embodiment 1 of the present invention and (ii) an insulating porous layer. Accordingly, the nonaqueous electrolyte secondary battery laminated separator in accordance with Embodiment 2 of the present invention includes a polyolefin porous film constituting the above-described nonaqueous electrolyte secondary battery separator in accordance with Embodiment 1 of the present invention.

[Insulating Porous Layer]

The insulating porous layer constituting the nonaqueous electrolyte secondary battery laminated separator in accordance with an embodiment of the present invention is typically a resin layer containing a resin. This insulating porous layer is preferably a heat-resistant layer or an adhesive layer. The insulating porous layer preferably contains a resin that is insoluble in an electrolyte of a battery and that is electrochemically stable when the battery is in normal use.

The porous layer is provided on one surface or both surfaces of the nonaqueous electrolyte secondary battery separator as needed. In a case where the porous layer is provided on one surface of the polyolefin porous film, the porous layer is preferably provided on that surface of the polyolefin porous film which surface faces a positive electrode of a nonaqueous electrolyte secondary battery to be produced, more preferably on that surface of the polyolefin porous film which surface comes into contact with the positive electrode.

Examples of the resin of which the porous layer is made encompass: polyolefins; (meth)acrylate-based resins; fluorine-containing resins; polyamide-based resins; polyimide-based resins; polyester-based resins; rubbers; resins with a melting point or glass transition temperature of not lower than 180° C.; and water-soluble polymers.

Among the above resins, polyolefins, acrylate-based resins, fluorine-containing resins, polyamide-based resins, polyester-based resins and water-soluble polymers are preferable. As the polyamide-based resins, wholly aromatic polyamides (aramid resins) are preferable. As the polyester-based resins, polyarylates and liquid crystal polyesters are preferable.

The porous layer may contain fine particles. The term “fine particles” herein means organic fine particles or inorganic fine particles generally referred to as a filler. Therefore, in a case where the porous layer contains fine particles, the above resin contained in the porous layer has a function as a binder resin for binding (i) fine particles together and (ii) fine particles and the porous film. The fine particles are preferably electrically insulating fine particles.

Examples of the organic fine particles contained in the porous layer encompass resin fine particles.

Specific examples of the inorganic fine particles contained in the porous layer encompass fillers made of inorganic matters such as calcium carbonate, talc, clay, kaolin, silica, hydrotalcite, diatomaceous earth, magnesium carbonate, barium carbonate, calcium sulfate, magnesium sulfate, barium sulfate, aluminum hydroxide, boehmite, magnesium hydroxide, calcium oxide, magnesium oxide, titanium oxide, titanium nitride, alumina (aluminum oxide), aluminum nitride, mica, zeolite, and glass. These inorganic fine particles are electrically insulating fine particles. The porous layer may contain only one kind of the fine particles or two or more kinds of the fine particles in combination.

Among the above fine particles, fine particles made of an inorganic matter is suitable. Fine particles made of an inorganic oxide such as silica, calcium oxide, magnesium oxide, titanium oxide, alumina, mica, zeolite, aluminum hydroxide, or boehmite are preferable. Further, fine particles made of at least one kind selected from the group consisting of silica, magnesium oxide, titanium oxide, aluminum hydroxide, boehmite, and alumina are more preferable. Fine particles made of alumina are particularly preferable.

A fine particle content of the porous layer is preferably 1% by volume to 99% by volume, and more preferably 5% by volume to 95% by volume with respect to 100% by volume of the porous layer. In a case where the fine particle content falls within the above range, it is less likely for a void, which is formed when fine particles come into contact with each other, to be blocked by a resin or the like. This makes it possible to achieve sufficient ion permeability and a proper weight per unit area of the porous layer.

The porous layer may include a combination of two or more kinds of fine particles which differ from each other in particle and/or specific surface area.

A thickness of the porous layer is preferably 0.5 μm to 15 μm (per single porous layer), and more preferably 2 μm to 10 μm (per single porous layer).

If the thickness of the porous layer is less than 1 μm, it may not be possible to sufficiently prevent an internal short circuit caused by breakage or the like of a battery. In addition, an amount of electrolyte to be retained by the porous layer may decrease. In contrast, if a total thickness of porous layers on both surfaces of the nonaqueous electrolyte secondary battery separator is above 30 μm, then a rate characteristic or a cycle characteristic may deteriorate.

The weight per unit area of the porous layer (per single porous layer) is preferably 1 g/m² to 20 g/m², and more preferably 4 g/m² to 10 g/m².

A volume per square meter of a porous layer constituent component contained in the porous layer (per single porous layer) is preferably 0.5 cm³ to 20 cm³, more preferably 1 cm³ to 10 cm³, and still more preferably 2 cm³ to 7 cm³.

For the purpose of obtaining sufficient ion permeability, a porosity of the porous layer is preferably 20% by volume to 90% by volume, and more preferably 30% by volume to 80% by volume. In order for a nonaqueous electrolyte secondary battery laminated separator to obtain sufficient ion permeability, a pore diameter of each of pores of the porous layer is preferably not more than 3 μm, and more preferably not more than 1 μm.

[Laminated Body]

A laminated body which is the nonaqueous electrolyte secondary battery laminated separator in accordance with Embodiment 2 of the present invention includes a nonaqueous electrolyte secondary battery separator in accordance with an embodiment of the present invention and an insulating porous layer. The laminated body is preferably arranged such that the above-described insulating porous layer is provided on one surface or both surfaces of the nonaqueous electrolyte secondary battery separator in accordance with an embodiment of the present invention.

The laminated body in accordance with an embodiment of the present invention has a thickness of preferably 5.5 μm to 45 μm, and more preferably 6 μm to 25 μm.

The laminated body in accordance with an embodiment of the present invention has an air permeability of preferably 30 sec/100 mL to 1000 sec/100 mL, and more preferably 50 sec/100 mL to 800 sec/100 mL, in terms of Gurley values.

The laminated body in accordance with an embodiment of the present invention may include, in addition to the polyolefin porous film and the insulating porous layer which are described above, a publicly known porous film(s) (porous layer(s)) such as a heat-resistant layer, an adhesive layer, and a protective layer according to need as long as such a porous film does not prevent an object of an embodiment of the present invention from being attained.

The laminated body in accordance with an embodiment of the present invention includes, as a base material, a nonaqueous electrolyte secondary battery separator configured such that the magnitude of the slope of the tangent in the region II of the ultrasonic attenuation rate curve falls within a specific range. This allows a nonaqueous electrolyte secondary battery containing the laminated body as a nonaqueous electrolyte secondary battery laminated separator to have a decreased battery resistance increasing rate after the charge and discharge (particularly after the degassing operation).

[Method for Producing Porous Layer and Method for Producing Laminated Body]

The insulating porous layer in accordance with an embodiment of the present invention and the laminated body in accordance with an embodiment of the present invention can be each produced by, for example, applying a coating solution (described later) to a surface of the polyolefin porous film of the nonaqueous electrolyte secondary battery separator in accordance with an embodiment of the present invention and then drying the coating solution so as to deposit the insulating porous layer.

Prior to applying the coating solution to a surface of the polyolefin porous film of the nonaqueous electrolyte secondary battery separator in accordance with an embodiment of the present invention, the surface to which the coating solution is to be applied can be subjected to a hydrophilization treatment as needed.

The coating solution for use in a method for producing the porous layer in accordance with an embodiment of the present invention and a method for producing the laminated body in accordance with an embodiment of the present invention can be prepared typically by (i) dissolving, in a solvent, a resin that may be contained in the porous layer described above and (ii) dispersing, in the solvent, fine particles that may be contained in the porous layer described above. The solvent in which the resin is to be dissolved here also serves as a dispersion medium in which the fine particles are to be dispersed. Depending on the solvent, the resin may be an emulsion.

The solvent (dispersion medium) is not limited to any particular one, provided that (i) the solvent does not have an adverse effect on the polyolefin porous film, (ii) the solvent allows the resin to be uniformly and stably dissolved in the solvent, and (iii) the solvent allows the fine particles to be uniformly and stably dispersed in the solvent. Specific examples of the solvent (dispersion medium) encompass water and organic solvents. Only one of these solvents can be used, or two or more of these solvents can be used in combination.

The coating solution may be prepared by any method that allows the coating solution to satisfy conditions such as the resin solid content (resin concentration) and the fine-particle amount that are necessary to produce a desired porous layer. Specific examples of the method of forming the coating solution encompass a mechanical stirring method, an ultrasonic dispersion method, a high-pressure dispersion method, and a media dispersion method. Further, the coating solution may contain, as a component(s) other than the resin and the fine particles, an additive(s) such as a disperser, a plasticizer, a surfactant, and/or a pH adjustor, provided that the additive does not prevent the object of an embodiment of the present invention from being attained. Note that the additive may be contained in an amount that does not prevent the object of an embodiment of the present invention from being attained.

A method of applying the coating solution to the polyolefin porous film, that is, a method of forming a porous layer on a surface of the polyolefin porous film is not limited to any particular one. The porous layer can be formed by, for example, (i) a method including the steps of applying the coating solution directly to a surface of the polyolefin porous film and then removing the solvent (dispersion medium), (ii) a method including the steps of applying the coating solution to an appropriate support, removing the solvent (dispersion medium) for formation of a porous layer, then pressure-bonding the porous layer to the polyolefin porous film, and subsequently peeling the support off, and (iii) a method including the steps of applying the coating solution to a surface of an appropriate support, then pressure-bonding the polyolefin porous film to that surface, then peeling the support off, and subsequently removing the solvent (dispersion medium).

The coating solution can be applied by a conventionally publicly known method. Specific examples of such a method include a gravure coater method, a dip coater method, a bar coater method, and a die coater method.

The solvent (dispersion medium) is typically removed by a drying method. The solvent (dispersion medium) contained in the coating solution may be replaced with another solvent before a drying operation.

### Embodiment 3: Nonaqueous Electrolyte Secondary Battery Member; Embodiment 4: Nonaqueous Electrolyte Secondary Battery]

A nonaqueous electrolyte secondary battery member in accordance with Embodiment 3 of the present invention is obtained by including a positive electrode, a nonaqueous electrolyte secondary battery separator in accordance with Embodiment 1 of the present invention or a nonaqueous electrolyte secondary battery laminated separator in accordance with Embodiment 2 of the present invention, and a negative electrode, the positive electrode, the nonaqueous electrolyte secondary battery separator or the nonaqueous electrolyte secondary battery laminated separator, and the negative electrode being disposed in this order.

A nonaqueous electrolyte secondary battery in accordance with Embodiment 4 of the present invention includes the nonaqueous electrolyte secondary battery separator in accordance with Embodiment 1 of the present invention or the nonaqueous electrolyte secondary battery laminated separator in accordance with Embodiment 2 of the present invention.

A nonaqueous electrolyte secondary battery in accordance with an embodiment of the present invention can be, for example, a nonaqueous secondary battery that achieves an electromotive force through doping with and dedoping of lithium, and can include a nonaqueous electrolyte secondary battery member including a positive electrode, a nonaqueous electrolyte secondary battery separator in accordance with an embodiment of the present invention, and a negative electrode, the positive electrode, the nonaqueous electrolyte secondary battery separator, and the negative electrode being disposed in this order. Alternatively, the nonaqueous electrolyte secondary battery in accordance with an embodiment of the present invention can be, for example, a nonaqueous secondary battery that achieves an electromotive force through doping with and dedoping of lithium, and can be a lithium-ion secondary battery that includes a nonaqueous electrolyte secondary battery member including a positive electrode, a porous layer, a nonaqueous electrolyte secondary battery separator in accordance with an embodiment of the present invention, and a negative electrode which are disposed in this order, that is, a lithium-ion secondary battery that includes a nonaqueous electrolyte secondary battery member including a positive electrode, a nonaqueous electrolyte secondary battery laminated separator in accordance with an embodiment of the present invention, and a negative electrode which are disposed in this order. Note that constituent elements, other than the nonaqueous electrolyte secondary battery separator, of the nonaqueous electrolyte secondary battery are not limited to those described below.

The nonaqueous electrolyte secondary battery in accordance with an embodiment of the present invention is typically arranged so that a battery element is enclosed in an exterior member, the battery element including (i) a structure in which the negative electrode and the positive electrode face each other via the nonaqueous electrolyte secondary battery separator in accordance with an embodiment of the present invention or the nonaqueous electrolyte secondary battery laminated separator in accordance with an embodiment of the present invention and (ii) an electrolyte with which the structure is impregnated.

The nonaqueous electrolyte secondary battery is preferably a secondary battery including a nonaqueous electrolyte, and is particularly preferably a lithium-ion secondary battery. Note that the doping means occlusion, support, adsorption, or insertion, and means a phenomenon in which lithium ions enter an active material of an electrode (e.g., a positive electrode).

A nonaqueous electrolyte secondary battery member in accordance with an embodiment of the present invention includes the nonaqueous electrolyte secondary battery separator in accordance with an embodiment of the present invention or the nonaqueous electrolyte secondary battery laminated separator in accordance with an embodiment of the present invention. Thus, the nonaqueous electrolyte secondary battery member in accordance with an embodiment of the present invention allows a nonaqueous electrolyte secondary battery into which the nonaqueous electrolyte secondary battery member is incorporated to have a decreased battery resistance increasing rate after charge and discharge (after the degassing operation) of this nonaqueous electrolyte secondary battery. The nonaqueous electrolyte secondary battery in accordance with an embodiment of the present invention includes the nonaqueous electrolyte secondary battery separator in accordance with an embodiment of the present invention configured such that the magnitude of the slope in the region II is adjusted to fall within a specific range. Thus, the nonaqueous electrolyte secondary battery in accordance with an embodiment of the present invention advantageously has a low battery resistance increasing rate after the charge and discharge (after the degassing operation).

<Positive Electrode>

A positive electrode included in the nonaqueous electrolyte secondary battery member in accordance with an embodiment of the present invention or in the nonaqueous electrolyte secondary battery in accordance with an embodiment of the present invention is not limited to any particular one, provided that the positive electrode is one that is generally used as a positive electrode of a nonaqueous electrolyte secondary battery. Examples of the positive electrode encompass a positive electrode sheet having a structure in which an active material layer containing a positive electrode active material and a binder resin is formed on a current collector. The active material layer may further contain an electrically conductive agent and/or a binding agent.

The positive electrode active material is, for example, a material capable of being doped with and dedoped of lithium ions. Specific examples of such a material encompass a lithium complex oxide containing at least one transition metal such as V, Mn, Fe, Co, or Ni.

Examples of the electrically conductive agent include carbonaceous materials such as natural graphite, artificial graphite, cokes, carbon black, pyrolytic carbons, carbon fiber, and a fired product of an organic polymer compound. It is possible to use only one kind of the above electrically conductive agents or two or more kinds of the above electrically conductive agents in combination.

Examples of the binding agent encompass (i) fluorine-based resins such as polyvinylidene fluoride, (ii) acrylic resin, and (iii) styrene butadiene rubber. Note that the binding agent serves also as a thickener.

Examples of the positive electrode current collector encompass electric conductors such as Al, Ni, and stainless steel. Among these, Al is preferable because Al is easily processed into a thin film and is inexpensive.

Examples of a method for producing the positive electrode sheet encompass: a method in which a positive electrode active material, an electrically conductive agent, and a binding agent are pressure-molded on a positive electrode current collector; and a method in which (i) a positive electrode active agent, an electrically conductive agent, and a binding agent are formed into a paste with the use of a suitable organic solvent, (ii) then, a positive electrode current collector is coated with the paste, and (iii) subsequently, the paste is dried and then pressured so that the paste is firmly fixed to the positive electrode current collector.

<Negative Electrode>

A negative electrode included in the nonaqueous electrolyte secondary battery member in accordance with an embodiment of the present invention or in the nonaqueous electrolyte secondary battery in accordance with an embodiment of the present invention is not limited to any particular one, provided that the negative electrode is one that is generally used as a negative electrode of a nonaqueous electrolyte secondary battery. Examples of the negative electrode encompass a negative electrode sheet having a structure in which an active material layer containing a negative electrode active material and a binder resin is formed on a current collector. The active material layer may further contain an electrically conductive agent.

Examples of the negative electrode active material encompass (i) a material capable of being doped with and dedoped of lithium ions, (ii) lithium metal, and (iii) lithium alloy. Examples of the material encompass carbonaceous materials. Examples of the carbonaceous materials encompass natural graphite, artificial graphite, cokes, carbon black, and pyrolytic carbons.

Examples of the negative electrode current collector encompass Cu, Ni, and stainless steel. Among these, Cu is more preferable because Cu is not easily alloyed with lithium especially in the case of a lithium ion secondary battery and is easily processed into a thin film.

Examples of a method for producing the negative electrode sheet encompass: a method in which a negative electrode active material is pressure-molded on a negative electrode current collector; and a method in which (i) a negative electrode active material is formed into a paste with the use of a suitable organic solvent, (ii) then, a negative electrode current collector is coated with the paste, and (iii) subsequently, the paste is dried and then pressured so that the paste is firmly fixed to the negative electrode current collector. The above paste preferably includes the above electrically conductive agent and the binding agent.

<Nonaqueous Electrolyte>

A nonaqueous electrolyte in a nonaqueous electrolyte secondary battery in accordance with an embodiment of the present invention is not limited to any particular one, provided that the nonaqueous electrolyte is one that is generally used for a nonaqueous electrolyte secondary battery. The nonaqueous electrolyte can be one prepared by, for example, dissolving a lithium salt in an organic solvent. Examples of the lithium salt encompass LiClO₄, LiPF₆, LiAsF₆, LiSbF₆, LiBF₄, LiCF₃SO₃, LiN(CF₃SO₂)₂, LiC(CF₃SO₂)₃, Li₂B₁₀Cl₁₀, lower aliphatic carboxylic acid lithium salt, and LiAlCl₄. It is possible to use only one kind of the above lithium salts or two or more kinds of the above lithium salts in combination.

Examples of the organic solvent to be contained in the nonaqueous electrolyte encompass carbonates, ethers, esters, nitriles, amides, carbamates, a sulfur-containing compound, and a fluorine-containing organic solvent obtained by introducing a fluorine group into any of these organic solvents. It is possible to use only one kind of the above organic solvents or two or more kinds of the above organic solvents in combination.

<Method of Producing Nonaqueous Electrolyte Secondary Battery Member and Method of Producing Nonaqueous Electrolyte Secondary Battery>

A nonaqueous electrolyte secondary battery member in accordance with an embodiment of the present invention can be produced by, for example, disposing the positive electrode, the nonaqueous electrolyte secondary battery separator in accordance with an embodiment of the present invention or the nonaqueous electrolyte secondary battery laminated separator in accordance with an embodiment of the present invention, and the negative electrode in this order.

Further, a nonaqueous electrolyte secondary battery in accordance with an embodiment of the present invention can be produced by, for example, (i) forming a nonaqueous electrolyte secondary battery member by the method described above, (ii) placing the nonaqueous electrolyte secondary battery member in a container which is to serve as a housing of the nonaqueous electrolyte secondary battery, (iii) filling the container with a nonaqueous electrolyte, and then (iv) hermetically sealing the container while reducing the pressure inside the container.

### EXAMPLES

The following description will discuss embodiments of the present invention in greater detail with reference to Examples and Comparative Examples. Note, however, that the present invention is not limited to the following Examples.

[Measurement Method]

The following method was used for measurement of physical properties and the like of each of polyolefin porous films produced in Examples and Comparative Examples below and measurement of a battery resistance increasing rate after a first charge and discharge of each of nonaqueous electrolyte secondary batteries which will be described later.

[Thickness of Film]

A thickness of each of the polyolefin porous films produced in Examples and Comparative Examples below was measured with the use of a high-precision digital measuring device (VL-50) manufactured by Mitutoyo Corporation.

[Weight Per Unit Area]

A sample in the form of an 8 cm square was cut out from each of the polyolefin porous films produced in Examples and Comparative Examples below, and the weight W(g) of the sample was measured. Then, the weight per unit area of the polyolefin porous film was calculated in accordance with the following Formula:

Weight per unit area (g/m²)=W/(0.08×0.08)

[Measurement of Ultrasonic Attenuation Rate]

Measurement of the ultrasonic attenuation rate was carried out with use of a dynamic liquid permeability measurement device manufactured by EMTEC Electronic GmbH (PDA.C.02 Module Standard). A specific method is described below (see FIG. 1).

A nonaqueous electrolyte was prepared in which EC, EMC, and DEC were mixed in a volume ratio of 3:5:2. Subsequently, the nonaqueous electrolyte was put into a tub 1 which was included with the dynamic liquid permeability measurement device, until the nonaqueous electrolyte reached a reference line of the tub 1.

Then, each of polyolefin porous films produced in Examples and Comparative Examples below (nonaqueous electrolyte secondary battery separators 3) was attached, with a double-sided tape included with the dynamic liquid permeability measurement device, to a sample holder 2 included with the dynamic liquid permeability measurement device in a sample attachment area provided on the sample holder 2. This prepared a specimen to be measured.

Subsequently, the specimen to be measured was attached to the dynamic liquid permeability measurement device, and measurement of the ultrasonic attenuation rate was carried out under the following measurement conditions, set with use of software which was included with the dynamic liquid permeability measurement device, in which algorithm was General, a measurement frequency was 2 MHz, and a measurement diameter was 10 mm.

The measurement of the ultrasonic attenuation rate was started with a press of a test start button of the dynamic liquid permeability measurement device. A time when the test start button was pressed was defined as t=0 ms. When the test start button was pressed, the specimen to be measured including the sample holder 2 started being dropped into the tub 1, which was filled with the nonaqueous electrolyte, at a constant velocity by use of a constant-velocity motor, and then reached a measurement position of the tub 1 after the elapse of a drop time (t=6 ms). Then, first measurement data of the ultrasonic attenuation rate was obtained at a time of t=7 ms, and thereafter, the ultrasonic attenuation rate was measured at a measurement interval of 4 ms. Immediately after the start of the measurement, a value corresponding to a least point that appeared on a vertical axis of a measurement state monitoring graph on a computer was written down, and the value corresponding to the least point was defined as a value of the ultrasonic attenuation rate at the time of t=7 ms. Note that although the least point is expressed in no unit on the computer, the least point indicates a value of a voltage of the DC-DC converter. Furthermore, the ultrasonic attenuation rate measured by the above-described method is expressed in the unit of mV.

[Calculation of Slope of Ultrasonic Attenuation Rate Curve in Region II]

From the measurements of the ultrasonic attenuation rate, changes in ultrasonic attenuation rate with the passage of time were plotted to generate an ultrasonic attenuation rate curve as shown in FIG. 2. In a region (region II) extending from a first inflection point, at which a decrease-to-increase conversion of the ultrasonic attenuation rate first occurred, to a second inflection point, at which an increase-to-decrease conversion of the ultrasonic attenuation rate occurred again, on the ultrasonic attenuation rate curve, a time when the first inflection point of the ultrasonic attenuation rate curve was reached after the start of the measurement was defined as t=B ms. A point corresponding to the value of the ultrasonic attenuation rate at t=B ms was connected to its subsequent given measurement points, and a tangent was drawn by using a least-squares method. Assuming that a time at which a correlation coefficient in the least-squares method was closest to 0.985 was t=C ms, an absolute value of a slope of a line connecting the points of the ultrasonic attenuation rate at t=B ms and at t=C ms was calculated. The absolute value of the slope thus calculated of the line was defined as a magnitude b of the slope in the region II of the ultrasonic attenuation rate.

Further, assuming that the ultrasonic attenuation rate at the first data measurement time of t=7 ms was 100%, another ultrasonic attenuation rate curve was generated by a method similar to the above-described method. Based on the another ultrasonic attenuation rate curve, a magnitude b′ of a slope of a tangent in the region II of the another ultrasonic attenuation rate curve was calculated by a method similar to the above calculation method.

[Battery Resistance Increasing Rate After Degassing Operation]

<Measurement of Battery Resistance Before Degassing Operation>

Battery resistance of each of nonaqueous electrolyte secondary batteries which had been produced in Examples and Comparative Examples and had not undergone charge and discharge was measured with use of an LCR meter manufactured by Hioki E.E. Corporation (product name: chemical impedance meter; type: 3532-80). Specifically, at room temperature of 25° C., a voltage having an amplitude of 10 mV was applied to each of the nonaqueous electrolyte secondary batteries, so that their respective Nyquist plots were obtained. Based on each of the Nyquist plots, a resistance value R_{10 Hz} of a real part of a measuring frequency of 10 Hz was calculated. The resistance value R_{10 Hz} was defined as a value of battery resistance before a degassing operation.

<Degassing Operation>

The nonaqueous electrolyte secondary batteries each of which had been subjected to measurement of battery resistance before the degassing operation were each subjected to one cycle of a first charge and discharge (first charging and discharging step). The one cycle of the first charge and discharge was carried out at 25° C., at a voltage ranging from 4.1 V to 2.7 V, with CC-CV charge at a charge current value of 0.1 C (terminal current condition: 0.02 C) and with CC discharge at a discharge current value of 0.2 C. Note that the value of an electric current at which a battery rated capacity defined as a one-hour rate discharge capacity is discharged in one hour is assumed to be 1 C. This also applies to the following descriptions. Note that the “CC-CV charge” is a charging method in which (i) a battery is charged at a constant electric current set, (ii) after a certain voltage is reached, the certain voltage is maintained while the electric current is being reduced. Note also that the “CC discharge is a discharging method in which a battery is discharged at a constant electric current until a certain voltage is reached.

Subsequently, in the nonaqueous electrolyte secondary battery after the first charge and discharge, the laminate pouch was cut at a margin portion (gas remaining portion) in which the positive and negative plates were not present within the laminate pouch with a resealing area remained, and was then evacuated by a vacuum sealer. This removed an excess gas component that had been generated by the first charge and discharge, and the laminate pouch of the nonaqueous electrolyte secondary battery was pressure-sealed again (degassing step).

<Measurement of Battery Resistance After Degassing Operation>

In a manner similar to the measurement of battery resistance before the degassing operation, a voltage having an amplitude of 10 mV was applied to each of the nonaqueous electrolyte secondary batteries which had been subjected to the degassing operation, so that their respective Nyquist plots were obtained. Then, based on each of the Nyquist plots, a resistance value R′_{10 Hz} of a real part of a measuring frequency of 10 Hz was calculated. The resistance value R′_{10 Hz} was defined as a value of battery resistance after the degassing operation.

<Calculation of Battery Resistance Increasing Rate After Degassing Operation>

A value of a ratio (%) of the battery resistance R′_{10 Hz} after the degassing operation to the battery resistance R_{10 Hz} before the degassing operation, which R_{10 Hz} had been obtained earlier, was calculated by (100×R′_{10 Hz}/R_{10 Hz}). The value thus calculated was defined as a battery resistance increasing rate (unit: %) after the degassing operation.

### Example 1

First, 18 parts by weight of ultra-high molecular weight polyethylene powder (Hi-Zex Million 145M, manufactured by Mitsui Chemicals, Inc.) and 2 parts by weight of hydrogenated petroleum resin (melting point: 164° C.;

softening point: 125° C.) were prepared. These powders were pulverized and mixed by a blender to obtain a mixture. Here, pulverization was carried out until particles of the powders had the same particle diameter. The mixture was fed into a twin screw kneader through a quantitative feeder and was then melt-kneaded to obtain a molten mixture.

At the time of melt-kneading, 80 parts by weight of liquid paraffin was side-fed under pressure into the twin screw kneader via a pump, and was melt-kneaded together with the mixture. At this time, an average temperature of (i) a temperature of a section (segment barrel 1) immediately in front of a section into which the liquid paraffin was fed and (ii) a temperature of the section into which the liquid paraffin was fed (segment barrel 2) was set to 173° C.

Thereafter, the molten mixture was extruded through a T-die, which was set to 210° C., via a gear pump. This prepared a sheet-shaped polyolefin resin composition.

The sheet-shaped polyolefin resin composition was stretched to 4.5 times in the MD direction and then stretched to 6.0 times in the TD direction. At the stretching, a value obtained by dividing the stretch magnification in the MD direction by the stretch magnification in the TD direction (hereinafter referred to as “stretch magnification ratio”) was 0.75. The stretched polyolefin resin composition was cleaned with a cleaning liquid (heptane). Thereafter, the cleaned polyolefin resin composition was dried at room temperature, and was then heat-fixed at a temperature of 132° C. for 15 minutes. This produced a polyolefin porous film. The polyolefin porous film thus produced is defined as a polyolefin porous film 1. The polyolefin porous film 1 had a thickness of 13 μm and a porosity of 32%.

### Example 2

A polyolefin porous film was produced by the same method as in Example 1 except that heat fixing was performed at a temperature of 120° C. for 1 minute. The polyolefin porous film thus produced is defined as a polyolefin porous film 2. The polyolefin porous film 2 had a thickness of 18 μm and a porosity of 56%.

### Example 3

A polyolefin porous film was produced by the same method as in Example 1 except that hydrogenated petroleum resin (melting point: 131° C.; softening point: 90° C.) was used, an average temperature of (i) a temperature of a section (segment barrel 1) immediately in front of a section into which a liquid paraffin was fed and (ii) a temperature of the section into which the liquid paraffin was fed (segment barrel 2) was set to 168° C., the polyolefin resin composition was stretched to 4.2 times in the MD direction and to 6.0 times in the TD direction at a stretch magnification ratio of 0.70, and heat fixing was performed at a temperature of 100° C. for 8 minutes. The polyolefin porous film thus produced is defined as a polyolefin porous film 3. The polyolefin porous film 3 had a thickness of 22 μm and a porosity of 60%.

### Comparative Example 1

A polyolefin porous film was produced by the same method as in Example 1 except that 20 parts by weight of ultra-high molecular weight polyethylene powder (Hi-Zex Million 145M, manufactured by Mitsui Chemicals, Inc.) was used, hydrogenated petroleum resin (melting point: 164° C.; softening point: 125° C.) was not added, an average temperature of (i) a temperature of a section (segment barrel 1) immediately in front of a section into which a liquid paraffin was fed and (ii) a temperature of the section into which the liquid paraffin was fed (segment barrel 2) was set to 165° C., the polyolefin resin composition was stretched to 3.2 times in the MD direction and to 6.0 times in the TD direction at a stretch magnification ratio of 0.53, and heat fixing was performed at a temperature of 133° C. for 15 minutes. The polyolefin porous film thus produced is defined as a polyolefin porous film 4. The polyolefin porous film 4 had a thickness of 13 μm and porosity of 37%.

### Comparative Example 2

First, 68% by weight of ultra-high molecular weight polyethylene powder (GUR2024, available from Ticona Corporation) and 32% by weight of polyethylene wax (FNP-0115; available from Nippon Seiro Co., Ltd.) having a weight-average molecular weight of 1000 were prepared, that is, 100 parts by weight in total of the ultra-high molecular weight polyethylene and the polyethylene wax were prepared. Then, 0.4 parts by weight of an antioxidant (Irg1010, available from Ciba Specialty Chemicals), 0.1 parts by weight of an antioxidant (P168, available from Ciba Specialty Chemicals), and 1.3 parts by weight of sodium stearate were added to the ultra-high molecular weight polyethylene and the polyethylene wax, and then calcium carbonate (available from Maruo Calcium Co., Ltd.) having an average particle diameter of 0.1 μm was further added by 38% by volume with respect to the total volume of the above ingredients. Then, the ingredients were mixed in powder form with use of a Henschel mixer, and were then melt-kneaded with use of a twin screw kneader. This produced a polyolefin resin composition. Then, the polyolefin resin composition was rolled with use of a pair of rollers each having a surface temperature of 150° C. into a sheet. The sheet was immersed in an aqueous hydrochloric acid solution (containing 4 mol/L of hydrochloric acid and 0.5% by weight of nonionic surfactant) for removal of the calcium carbonate from the sheet. Subsequently, the calcium carbonate-removed sheet was stretched to 6.2 times in the TD direction at a stretch temperature of 105° C. to produce a polyolefin porous film. The polyolefin porous film thus produced is defined as a polyolefin porous film 5. The polyolefin porous film 5 had a thickness of 16 μm and a porosity of 65%.

[Production of Nonaqueous Electrolyte Secondary Battery]

Each of nonaqueous electrolyte secondary batteries was prepared by a method provided below with use of, as a nonaqueous electrolyte secondary battery separator, the corresponding one of the polyolefin porous films 1 to 5 produced in Examples 1 to 3 and Comparative Examples 1 and 2, respectively.

(Preparation of Positive Electrode)

A commercially available positive electrode was used that was produced by applying LiNi_{0.5}Mn_{0.3}Co_{0.2}O₂/electrically conductive agent/PVDF (weight ratio of 92:5:3) to an aluminum foil. The aluminum foil was partially cut off so that a positive electrode active material layer was present in an area of 45 mm×30 mm and that that area was surrounded by an area with a width of 13 mm in which area no positive electrode active material layer was present. A portion thus cut was used as a positive electrode. The positive electrode active material layer had a thickness of 58 μm and a density of 2.50 g/cm³. The positive electrode had a capacity of 174 mAh/g.

(Preparation of Negative Electrode)

A commercially available negative electrode was used that was produced by applying graphite/styrene-1,3-butadiene copolymer/sodium carboxymethylcellulose (weight ratio of 98:1:1) to a copper foil. The copper foil was partially cut off so that a negative electrode active material layer was present in an area of 50 mm×35 mm and that that area was surrounded by an area with a width of 13 mm in which area no negative electrode active material layer was present. A portion thus cut was used as a negative electrode. The negative electrode active material layer had a thickness of 49 μm and a density of 1.40 g/cm³. The negative electrode had a capacity of 372 mAh/g.

(Assembly of Nonaqueous Electrolyte Secondary Battery)

In a laminate pouch, the positive electrode, the polyolefin porous film as the nonaqueous electrolyte secondary battery separator, and the negative electrode were disposed (arranged to form a laminate) in this order so as to obtain a nonaqueous electrolyte secondary battery member. During this operation, the positive electrode and the negative electrode were arranged so that the positive electrode active material layer of the positive electrode had a main surface that was entirely covered by the main surface of the negative electrode active material layer of the negative electrode.

Subsequently, the nonaqueous electrolyte secondary battery member was put into a bag made of a laminate of an aluminum layer and a heat seal layer. Further, 0.25 mL of nonaqueous electrolyte was put into the bag. The nonaqueous electrolyte was an electrolyte at 25° C. prepared by dissolving LiPF₆ in a mixed solvent of ethyl methyl carbonate, diethyl carbonate, and ethylene carbonate in a volume ratio of 50:20:30 so that the concentration of LiPF₆ in the electrolyte was 1.0 mole per liter. The bag was then heat-sealed while the pressure inside the bag was reduced. This produced a nonaqueous electrolyte secondary battery. The nonaqueous electrolyte secondary battery 1 had a design capacity of 20.5 mAh. Note, here, that nonaqueous electrolyte secondary batteries each produced by using a corresponding one of the polyolefin porous films 1 to 5 as the polyolefin porous film are defined as nonaqueous electrolyte secondary batteries 1 to 5, respectively.

[Results]

Table 1 below shows the “magnitude b of the slope in the region II of the ultrasonic attenuation rate curve” and the “magnitude b′ of the slope in the region II of the ultrasonic attenuation rate curve” of each of the polyolefin porous films 1 to 5 which were produced in Examples 1 to 3 and Comparative Examples 1 and 2, respectively, and the “battery resistance increasing rate after the degassing operation” of each of the nonaqueous electrolyte secondary batteries 1 to 5 which was produced by using the corresponding one of the polyolefin porous films 1 to 5 produced in Examples 1 to 3 and Comparative Examples 1 and 2, respectively.

TABLE 1

| | Magnitude b of | Magnitude b′ of | |
|---|---|---|---|
| | slope in region | slope in region | Battery resistance |
| | II of ultrasonic | II of ultrasonic | increasing rate after |
| | attenuation rate | attenuation rate | degassing operation |
| | curve [mV/s] | curve [%/s] | [%] |
| Example 1 | 127 | 0.8 | 97 |
| Example 2 | 718 | 5.4 | 94 |
| Example 3 | 1399 | 9.6 | 96 |
| Comparative | 89 | 0.4 | 102 |
| Example 1 | | | |
| Comparative | 1485 | 10.4 | 120 |
| Example 2 | | | |

[Conclusion]

For the polyolefin porous films 1 to 3 produced in Examples 1 to 3, respectively, the magnitude b of the slope in the region II of the ultrasonic attenuation rate curve is not less than 100 mV/s to not more than 1450 mV/s. In contrast, for the polyolefin porous films 4 and 5 produced in Comparative Examples 1 and 2, respectively, the magnitude b of the slope in the region II of the ultrasonic attenuation rate curve falls outside the above range.

Referring to Table 1, the battery resistance increasing rate after the degassing operation of each of the nonaqueous electrolyte secondary batteries into which the corresponding one of the nonaqueous electrolyte secondary battery separators including the corresponding one of the polyolefin porous films 4 and 5 which had been produced in Comparative Examples 1 and 2, respectively, was incorporated is above 100%. In contrast, the battery resistance increasing rate after the degassing operation of each of the nonaqueous electrolyte secondary batteries into which the corresponding one of the nonaqueous electrolyte secondary battery separators including the corresponding one of the polyolefin porous films 1 to 3 was incorporated is less than 100%. From this result, it is revealed that each of the nonaqueous electrolyte secondary batteries into which the corresponding one of the nonaqueous electrolyte secondary battery separators including the corresponding one of the polyolefin porous films 1 to 3 was incorporated has a lower battery resistance increasing rate after the degassing operation in comparison to each of the nonaqueous electrolyte secondary batteries into which the corresponding one of the nonaqueous electrolyte secondary battery separators including the corresponding one of the polyolefin porous films 4 and 5 which had been produced in Comparative Examples 1 and 2, respectively, was incorporated.

That is, it is revealed that a nonaqueous electrolyte secondary battery separator in accordance with an embodiment of the present invention allows a nonaqueous electrolyte secondary battery to decrease an increase in battery resistance after the degassing operation.

### INDUSTRIAL APPLICABILITY

A nonaqueous electrolyte secondary battery separator in accordance with an embodiment of the present invention allows a nonaqueous electrolyte secondary battery including the nonaqueous electrolyte secondary battery separator to reduce an increase in battery resistance after a degassing operation. Thus, a nonaqueous electrolyte secondary battery separator in accordance with an embodiment of the present invention is suitably applicable in various industries which deal with nonaqueous electrolyte secondary batteries.

### REFERENCE SIGNS LIST

1: Tub

2: Sample holder

3: Nonaqueous electrolyte secondary battery separator

1. A nonaqueous electrolyte secondary battery separator comprising:
a polyolefin porous film,
wherein a magnitude of a slope of a tangent in a region II of an ultrasonic attenuation rate curve of the nonaqueous electrolyte secondary battery separator immersed in an electrolyte is not less than 100 mV/s to not more than 1450 mV/s,
where the ultrasonic attenuation rate curve shows changes over time in ultrasonic attenuation rate of a 2 MHz ultrasonic wave emitted to the nonaqueous electrolyte secondary battery separator immersed in the electrolyte, and the region II indicates, on the ultrasonic attenuation rate curve, a region extending from a first inflection point of the ultrasonic attenuation rate to a second inflection point of the ultrasonic attenuation rate.

2. A nonaqueous electrolyte secondary battery laminated separator comprising:
a nonaqueous electrolyte secondary battery separator recited in claim 1; and
an insulating porous layer.

3. A nonaqueous electrolyte secondary battery member comprising:
a positive electrode;
a nonaqueous electrolyte secondary battery separator recited in claim 1; and
a negative electrode,
the positive electrode, the nonaqueous electrolyte secondary battery separator, and the negative electrode being arranged in this order.

4. A nonaqueous electrolyte secondary battery comprising:
a nonaqueous electrolyte secondary battery separator recited in claim 1.

5. A nonaqueous electrolyte secondary battery member comprising:
a positive electrode;
a nonaqueous electrolyte secondary battery laminated separator recited in claim 2; and
a negative electrode,
the positive electrode, the nonaqueous electrolyte secondary battery laminated separator, and the negative electrode being arranged in this order.

6. A nonaqueous electrolyte secondary battery comprising:
a nonaqueous electrolyte secondary battery laminated separator recited in claim 2.
